(19) United States
(12) Patent Application Publication
(10) Pub. No.: US 2013/0287663 A1
(43) Pub. Date: Oct. 31, 2013

(54) SYSTEM, SORBENTS, AND PROCESSES FOR CAPTURE AND RELEASE OF CO2

(71) Applicants: Keling Zhang, Storrs, CT (US); David L. King, Richland, WA (US); Xiaohong S. Li, Richland, WA (US); Liyu Li, Richland, WA (US); Aashish Rohatgi, Richland, WA (US); Prabhakar Singh, Storrs, CT (US)

(72) Inventors: Keling Zhang, Storrs, CT (US); David L. King, Richland, WA (US); Xiaohong S. Li, Richland, WA (US); Liyu Li, Richland, WA (US); Aashish Rohatgi, Richland, WA (US); Prabhakar Singh, Storrs, CT (US)

(73) Assignees: UNIVERSITY OF CONNECTICUT, Storrs, CT (US); BATTELLE MEMORIAL INSTITUTE, Richland, WA (US)

(21) Appl. No.: 13/776,474

(22) Filed: Feb. 25, 2013

Related U.S. Application Data
(60) Provisional application No. 61/638,603, filed on Apr. 26, 2012.

(51) Int. Cl. B01D 53/14; B01J 20/04

(52) U.S. Cl. CPC B01D 53/14; B01J 20/041
USPC 423/230; 252/184; 422/129

(57) ABSTRACT

A system, sorbent formulations, methods of preparation, and methods are described that provide selective sorption and release of CO₂ from CO₂-containing gases such as syngas. The sorbent may include magnesium oxide (MgO) and a group-I alkali metal nitrate. The sorbent may also include a group-I alkali metal carbonate and/or a group-II alkaline-earth metal carbonate.

### CROSS REFERENCE TO RELATED APPLICATIONS

This application claims priority from U.S. Provisional Patent Application No. 61/638,603 filed 26 Apr. 2012 entitled “Device, Process, and Composition for Capture and Release of CO₂”, which reference is incorporated in its entirety herein.

### STATEMENT REGARDING RIGHTS TO INVENTION MADE UNDER FEDERALLY-SPONSORED RESEARCH AND DEVELOPMENT

This invention was made with Government support under Contract DE-AC05-76RLO1830 awarded by the U.S. Department of Energy. The Government has certain rights in the invention.

### FIELD OF THE INVENTION

The present invention relates generally to capture and removal of carbon dioxide (CO₂) present in industrial effluents. More particularly, the invention relates to sorbents, devices, and processes for removal of CO₂ present in industrial process streams and effluents.

### BACKGROUND OF THE INVENTION

Syngas can be generated by gasification of coal or biomass and used for the production of fuels and chemicals. Syngas derived from coal must be cleaned of impurities. Currently, syngas clean-up employs the RECTISOL™ process in which chilled methanol captures the impurities at ambient or lower temperatures. After cleaning, syngas is then re-heated to a suitable reaction temperature typically between 200° C. and 350° C. However, both the cooling and re-heating of the gas is inefficient. For this reason, warm temperature cleanup is desirable. Capture of CO2 is also becoming increasingly important as a means to avoid climate change. Although the RECTISOL™ process captures CO2 when present in a syngas obtained from a gasifier, CO2 must be captured and released under warm temperature conditions if the RECTISOL™ process were to be replaced for energy efficiency reasons. One possibility would be to capture CO2 in the syngas during use with the same warm temperature CO2 sorbent. In addition, devices containing this sorbent could enable capture of CO2 in a manner that facilitates conversion of syngas by avoiding equilibrium limitations (e.g., during water-shift reactions).

An answer to the inefficiency problem could involve a warm gas cleanup of the syngas coupled with a warm temperature capture of CO₂. MgO is one oxide that can operate over this temperature range. While MgO has a theoretical sorption capacity for CO₂ of about 25 mmol/g (i.e., below 300° C. and 1 atm pressure), MgO is actually a poor absorber of CO₂, with a sorption capacity about two orders of magnitude lower than its theoretical capacity. Thus, a problem remains how to effectively activate MgO to maximize CO₂ capture for removing CO₂ from gaseous process streams at suitable warm gas temperatures. The present invention addresses these needs.

### BRIEF DESCRIPTION OF THE DRAWINGS

FIG. 1 is an SEM showing an exemplary sorbent of the present invention for capture of CO₂.

FIG. 2 presents XRD results showing sorbent component phases.

FIG. 3 shows sorbent component phases in-situ following sorption and desorption, respectively.

FIG. 4 shows CO₂ sorption results for one sorbent of the present invention at a selected sorption temperature under pressure swing test conditions.

FIG. 5 shows CO₂ sorption results for dolomite with and without addition of alkali-metal nitrate at a selected sorption temperature under pressure swing test conditions.

FIG. 6 shows CO₂ sorption results for another sorbent of the present invention at a selected sorption temperature under pressure swing test conditions.

FIG. 7 shows effect of alkali-metal nitrate salt addition on CO₂ sorption results in another sorbent embodiment of the present invention.

FIG. 8 shows a schematic of a fixed-bed reactor and exemplary conditions for warm temperature removal of CO₂ in concert with the present invention.

FIG. 9 shows CO2 sorption capacity for an exemplary sorbent of the present invention as a function of cycle number in a fixed bed reactor.

FIG. 10 is a CO2 sorption break-through curve for a sorbent of the present invention showing CO2 concentration in an off gas stream as a function of time.

### SUMMARY OF THE PRESENT INVENTION

The present invention includes a system, sorbent compositions, and a process for selective capture and release of CO₂ from CO₂-containing gases.

In some applications, the sorbent may include magnesium oxide (MgO) and one or more alkali-metal nitrates. In some applications, the sorbent may include a magnesium oxide concentration between about 40 wt % and about 98 wt %. The nitrates may have a concentration between about 2 wt % and about 60 wt %.

In some applications, the sorbent may include a Group-I alkali metal carbonate and/or a Group-II alkaline-earth metal carbonate. In some applications, the sorbent may include one or more carbonates including, e.g., Na₂CO₃, Li₂CO₃, K₂CO₃, and CaCO₃. In some applications, the sorbent may also include alkali-metal nitrates, nitrites, and eutectic mixtures of these various nitrate and nitrite salts.

In some applications, the sorbent may include a magnesium oxide concentration between about 20 wt % and about 66 wt %. The nitrates may have a concentration between about 4 wt % and about 40 wt %. And, the group-I alkali metal carbonates and/or the group-II alkaline earth metal carbonates may have a concentration between about 30 wt % and about 75 wt %.

In some applications, the sorbent may include a magnesium oxide concentration between about 40 wt % and about 92 wt %. The nitrates may have a concentration between about 4 wt % and about 40 wt %. And, the group-I alkali metal carbonates and/or group-II alkaline earth metal carbonates may have a concentration between about 4 wt % and about 50 wt %.

In some applications, the alkali-metal nitrates may also include one or more alkali-metal nitrites or their eutectic mixtures of these various salts that melt and wet the surface of the solid phase components in the sorbent at the selected sorption temperature.

Sorption of CO2 by the sorbent forms a regenerable (reversible) solid metal carbonate salt product at a temperature above ambient and below 600° C. Sorption of CO2 by the sorbent may remove CO2 from the CO2-containing gas that yields a CO₂-depleted gas.

In some applications, the reversible solid metal carbonate salt product may include MgCO3.

In some applications, the reversible solid metal carbonate salt product may include (M)₂Mg(CO₃)₂ where (M) is a Group-I alkali metal and/or forming (M)Mg(CO₃)₂ where (M) is a Group-II alkaline-earth metal.

In some applications, the reversible solid metal carbonate salt product may include MgCO₃ and (M)₂Mg(CO₃)₂ where (M) is a Group-I alkali metal and/or (M)Mg(CO₃)₂ where (M) is a Group-II alkaline-earth metal.

The present invention may also include a system for removing CO₂ from a CO₂-containing gas. The system may include a reactor configured to contain a sorbent that includes a mixture of magnesium oxide and one or more alkali-metal nitrates, and optionally an alkali metal carbonate and/or an alkaline-earth metal carbonate. The sorbent may be configured to sorb CO₂ from the CO₂-containing gas at a selected sorption temperature above ambient and below 600° C. that in operation forms a reversible solid metal carbonate salt upon sorption of CO₂ to yield a CO₂-depleted gas. In operation, the nitrate and nitrite salts in the sorbent may be in a molten state while the MgO in the sorbent is in a solid state.

The present invention may also include a method for removing CO₂ from a CO₂-containing gas. The method may include sorption of CO₂ by the sorbent from the CO₂-containing gas at selected temperatures above ambient and below 600° C.

In some applications, sorption of CO2 may be performed at a sorption temperature up to about 360° C.; or between about 300° C. and about 360° C.

In some applications, sorption of CO2 may be performed at a sorption temperature between about 380° C. and about 450° C.

In some applications, sorption of CO2 may be performed at a sorption temperature up to about 375° C. or between about 300° C. and about 375° C.

At the sorption temperature, the sorbent may be comprised of multiple phases. In some applications, the sorbent may include a mixture of magnesium oxide in a solid state and one or more alkali-metal nitrates in a molten state. The sorbent may optionally include an alkali metal carbonate and/or an alkaline-earth metal carbonate.

In some applications, the sorbent may include a sorption capacity for CO2 up to about 55 wt %; or up to about 108 wt %.

In some applications, the sorbent may include a sorption capacity for CO2 up to about 20 wt %; or up to about 30 wt %.

In some applications, the sorbent may include a sorption capacity for CO2 up to about 71 wt %; or up to about 101 wt %.

The method may include regenerating the sorbent by releasing CO₂ from the sorbent that regenerates the sorbent. In various applications, regeneration of the sorbent may include releasing CO₂ from the sorbent to restore the MgO and/or the Group-I and/or Group-II metal carbonates in the sorbent from the reversible (regenerable) solid metal carbonate salt product form of the sorbent.

Regeneration of the sorbent may include a thermal swing, a pressure swing, or a combination of a temperature-swing and a pressure-swing. The thermal swing may include changing the temperature of the sorbent from a sorption temperature to a desorption temperature or vice versa. The thermal swing can include a temperature equal to or greater than about 400° C. and below 600° C. The pressure swing may include changing the partial pressure of the CO₂-containing gas introduced to the sorbent at a fixed temperature. The pressure swing may include purging the sorbent with a purge gas to release CO₂ from the sorbent. Purge gases may include, but are not limited to, e.g., steam, inert gases, nitrogen-containing gases, CO₂-free gases, and combinations of these various gases.

The regeneration may be performed in a reactor in which a temperature-swing, a pressure-swing, or a combination of temperature swing and pressure swing are used to release CO₂ from the sorbent to regenerate the sorbent in the reactor.

The purpose of the foregoing abstract is to enable the United States Patent and Trademark Office and the public generally, especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### DETAILED DESCRIPTION

The present invention includes a system, sorbent formulations, methods for preparation, and methods for capture and release of CO₂ from CO₂-containing gases. CO₂-containing gases include, but are not limited to, e.g., pre-combustion syngas generated from gasification of coal, biomass, or other heavy hydrocarbon sources. The following description includes a best mode of the present invention. While preferred embodiments of the present invention will now be described, the invention is not intended to be limited thereto. For example, it will be apparent that various modifications, alterations, and substitutions to the present invention may be made. The invention is intended to cover all modifications, alternative constructions, and equivalents falling within the spirit and scope of the invention as defined in the claims listed hereafter. Accordingly, the description of exemplary embodiments should be seen as illustrative only and not limiting.

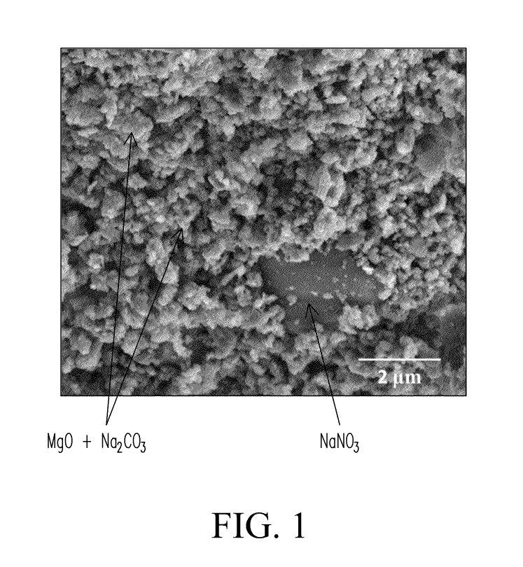

FIG. 1 is a Scanning Electron Micrograph (SEM) that shows components of one sorbent of the present invention. The sorbent may include magnesium metal oxide (MgO), an alkali-metal carbonate salt (e.g., Na2CO3), and an alkali-metal nitrate salt (e.g., NaNO3). The micrograph shows a smooth phase indicative of NaNO3, and a coarse phase composed of both MgO and the Na2CO3 salt. “Salt” as used herein means a chemical compound with a metal cation ionically bound to a non-metal anion.

### Sorbent Preparation

An exemplary process will now be described for preparation (e.g., large-scale synthesis of >100 grams) of a CO₂ capture sorbent of the present invention that removes CO₂ from CO₂-containing gases, according to one embodiment of the present invention. The sorbent includes alkali-metal nitrate salts. The process provides a sorbent that is easily produced without strict requirements for preparation. While the process for preparation of different sorbent materials will be described in reference to a ball milling approach, the present invention is not intended to be limited thereto. For example, in some embodiments, MgO present within the sorbent may be prepared as detailed, e.g., by Mayorga et al. in U.S. Pat. No. 6,280,503B1, which reference is incorporated herein in its entirety. In other embodiments detailed herein, sorbents may include, e.g., alkali-metal nitrate salts, alkali-metal nitrite salts, alkali-metal carbonates (e.g., Na₂CO₃), and alkaline-earth metal carbonates (e.g., CaCO₃). Other aspects of sorbents described herein are detailed by Zhang et al. (in “Roles of double salt formation and NaNO₃ in Na₂CO₃-promoted MgO absorbents for intermediate temperature CO₂ removal”, International Journal of Greenhouse Gas Control 12 (2013) 351-358), which reference is incorporated in its entirety herein.

The method may include introducing one or more of the solid constituents together at selected concentrations in a medium selected to form a slurry mixture containing particles of a selected size. In some embodiments, the particle size may be about 200 nm. But, particle sizes are not intended to be limited. In a preferred embodiment, constituents may be ball-milled together to achieve intimate mixing of the components. The slurry mixture may be dried at a temperature selected to form a dry powder cake that retains the alkali-metal nitrate (e.g., NaNO₃) in the sorbent. Drying of the slurry permits particles in the powder cake to settle and form agglomerates. In some embodiments, a drying temperature below 100° C. may be preferred, but drying temperatures are not intended to be limited.

The dry powder cake may then be activated. The term “activation” means heating the solids in the powder cake to any temperature that removes the milling medium, that converts any MgCO₃ present in the sorbent to MgO (a primary reactant), and that melts the alkali-metal nitrate salts in the sorbent and distributes the molten nitrate throughout the sorbent mixture. Re-solidifying nitrate salts in the sorbent mixture serves to bind loose particles in the sorbent together forming agglomerated or bulk solid sorbent pieces with desired particle sizes and desired particle properties (e.g., mechanical strength) detailed hereafter. Choice of activation temperatures depends at least in part on properties of the selected sorbent materials, temperatures needed to remove any prior or advanced sorption of CO2, and temperatures that do not allow decomposition of any alkali-metal nitrates and nitrates present within the sorbent mixtures. In some embodiments, an activation temperature of 450° C. may be employed. However, temperatures are not intended to be limited. Thus, all temperatures as will be selected by those of ordinary skill in the art in view of the disclosure are within the scope of the invention.

### Particle Size

In some embodiments, agglomerated sorbent pieces may be used directly. Nitrate salts in the sorbent may provide a “glue-like effect” that permits agglomerated sorbent particles to be ground down to produce sorbent particles with various selected or desired sizes and desired properties for selected applications.

In various embodiments, agglomerated sorbent pieces formed after re-solidification of nitrate and/or nitrite salts in the sorbent may have a size ranging from sub-centimeter to centimeter-sized pieces. For example, in some reactor applications or engineering applications, larger sorbent particles may be best suited. Larger particles can increase the mechanical strength of the agglomerated sorbent in these applications and prevent sorbent pieces from breaking down into fine powders during operation. Mechanical strength can also be adjusted by varying concentrations of nitrate and/or nitrite salts in the sorbent. Sorbent performance may be optimized by controlling ball milling parameters. In addition, particles sizes may be selected that allow effluent gases to pass through the agglomerated particles. In some applications, size of sorbent particles may be selected based on the bed height and reactor volume that best reduces pressure drops when passing gas streams through the sorbent bed of the reactor. All particle sizes as will be selected by those of ordinary skill in the art in view of the disclosure are within the scope of the invention. No limitations are intended.

### Milling Media

Liquid media suitable for use include, but are not limited to, e.g., isopropyl alcohol, 2-propanol, ethanol, acetone, including combinations of these liquids. Preferred media permit milling but do not allow sorbent constituents to dissolve in the medium, or to crystallize out from solution during drying. The approach yields a uniform chemistry in the sorbent.

Amount of milling media needed may be based on the solid loading factor. “Solid Loading Factor” as defined herein means the total quantity of solids divided by the combined quantity of liquid medium and the total solids in the liquid medium.

In some embodiments, solid loading factor for syntheses detailed herein may be in the range from about 10 wt % to about 25 wt %. In some embodiments, solid loading factor may be in the range up to about 50 wt %; or up to about 75 wt %. No limitations are intended. Loading factors may be optimized to shorten milling times, as will be understood by those of ordinary skill in the ball milling arts in view of this disclosure. No limitations are intended.

### Milling Time

Milling times are not limited. Milling times may be affected by milling factors including, but not limited to, e.g., solid loading factors, quantity of milling beads, rotation speed.

### Sorbent Systems

Various sorbent systems of the present invention will now be described. In some embodiments, sorbents may include MgO mixed with one or more alkali-metal nitrates. In some embodiments, sorbents of may include MgO mixed with one or more alkali-metal nitrates, alkali-metal carbonates or alkaline-earth carbonates. Sorbents may all include nitrites or eutectic mixtures of nitrates and nitrites. These sorbents are regenerable (reversible) sorbents that provide sorption of CO2 at selected temperatures suitable and convenient for, e.g., warm gas cleanup. “Warm gas” as used herein means a gas maintained at a temperature in the range from about 100° C. to about 600° C. As will be appreciated by those of ordinary skill in the art, sorption temperatures will depend in part on the concentration of CO2 in the gas, the desired sorption temperature, the temperature and pressures at which the sorption is performed, concentrations of sorbent constituents including, but not limited to, e.g., metal carbonates (e.g., alkali-metal carbonates and alkaline-earth carbonates), promoters including alkali-metal nitrates and alkali-metal nitrites, eutectics of these various nitrates and nitrites, as well as the pressure swing and/or temperature swing conditions used to recover the CO2 gas and regenerate the sorbent. Thus, no limitations are intended.

In some embodiments, the sorbent may contain magnesium metal oxide (MgO) at a concentration of from about 40 wt % to about 98 wt %; and an alkali-metal nitrate salt such as NaNO₃ at a concentration of from about 2 wt % to about 60 wt %. In this sorbent, sorption of CO₂ by the sorbent may form a reversible metal carbonate salt given by the reaction in [1]:

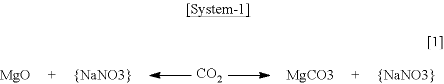

In this system, the reversible metal carbonate salt formed upon sorption of CO2 is exclusively MgCO3. Sorption temperature for the sorbent may be from about 300° C. to about 360° C.

In some embodiments, the sorbent may contain constituents including, e.g., MgO at a concentration of from about 20 wt % to about 70 wt %; an alkali-metal nitrate salt such as NaNO₃ at a concentration of from about 4 wt % to about 40 wt %; and a group-I alkali metal carbonate (e.g., Na2CO3) or a group-II alkaline-earth metal carbonate (e.g., CaCO3) at a concentration of from about 30 wt % to about 75 wt %. In this sorbent system, sorption of CO₂ may yield a product that is a single reversible metal carbonate salt given by the reaction in [2] or [3]:

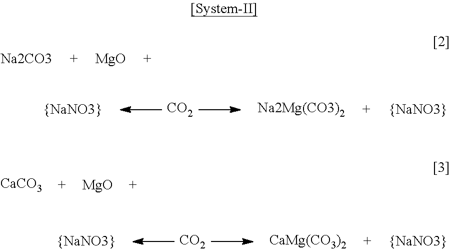

Here, the reversible metal carbonate salt product has the form M2Mg(CO3)2 or MMg(CO3)2 where (M) is an group-I alkali-metal or a group-II alkaline-earth metal. In reaction [3], uptake of CO2 by MgO in the sorbent may again be promoted by the alkali-metal nitrate salt (e.g., NaNO₃) and the solid carbonate additive (e.g., CaCO₃) that promotes reaction with CO2 to form the reversible carbonate salt. In these embodiments, no MgCO3 forms. Sorption temperatures for the sorbent may be from about 380° C. to about 450° C.

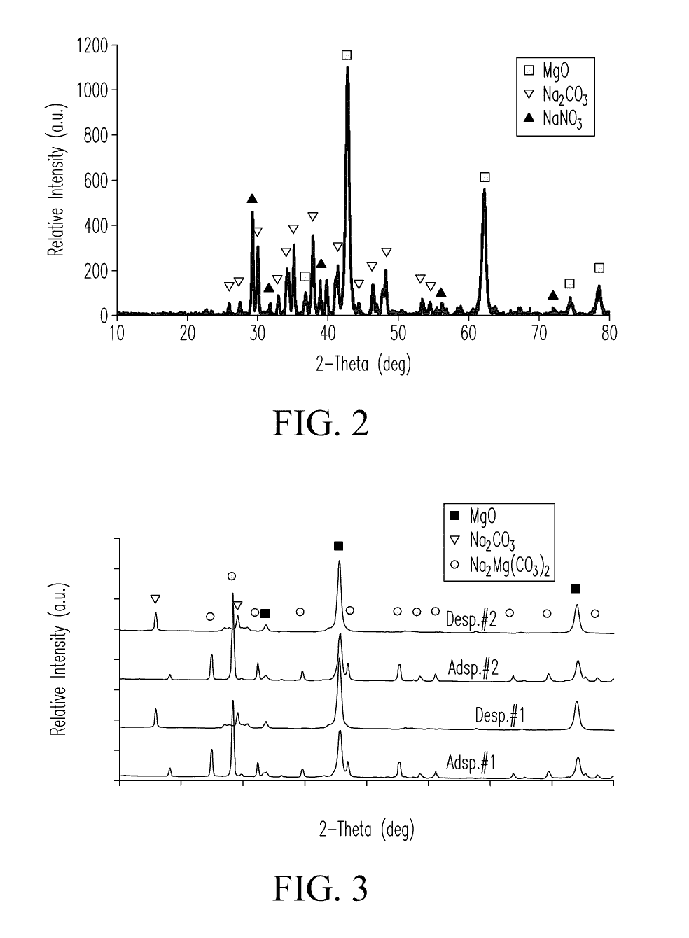

FIG. 2 shows a XRD scan of a solid sorbent (e.g., of a System-II type) of the present invention prior to use that shows starting component phases in the sorbent, including the MgO, the alkali-metal carbonate (e.g., Na2CO3), and the alkali-metal nitrate promoter (e.g., NaNO3).

In some embodiments, the sorbent may contain MgO at a concentration of from about 40 wt % to about 96 wt %; an alkali-metal nitrate salt such as NaNO₃ at a concentration of from about 4 wt % to about 40 wt %; and a group-I alkali metal carbonate or a group-II alkaline-earth metal carbonate at a concentration of from about 4 wt % to about 50 wt %. In these embodiments, sorption of CO2 by the sorbent may occur at lower temperatures as detailed further herein to yield a reversible metal carbonate salt as given by the reaction in Equation [4] or Equation [5]:

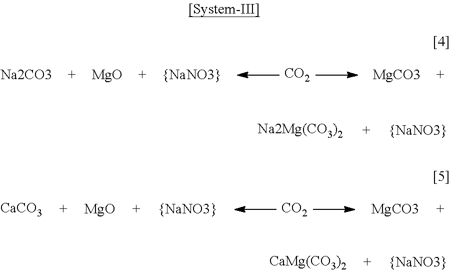

In these embodiments, the reversible metal carbonate salt product may include two salts, i.e., MgCO3 and a salt having the form M₂Mg(CO₃)₂ where (M) is a group-I alkali-metal (e.g., Na) and/or MMg(CO₃) where (M) is a group-II alkaline-earth metal (e.g., Ca). Uptake of CO2 by MgO again may be promoted by the alkali-metal nitrate salt (e.g., NaNO₃) and the carbonate reactant added to the sorbent (e.g., Na₂CO₃ or CaCO₃).

Sorption temperature for the sorbent may be between about 300° C. and about 400° C. In some embodiments, sorbents of the present invention may sorb CO₂ at selected sorption temperatures between about 300° C. and about 500° C. In some embodiments, sorption temperature for the sorbent may be more particularly in the range from about 300° C. to about 375° C.

### Sorption Phases

Phases of selected sorbents upon sorption of CO2 may be identified, e.g., by X-ray diffraction (XRD) (e.g., a D8 ADVANCE analyzer, Bruker Corp., Billerica, Mass. USA) using, e.g., Cu Kalpha (α) radiation at a scanning rate of 2°/minute.

FIG. 3 shows an XRD scan collected in-situ for a representative sorbent (e.g., of System-II) of the present invention at a selected sorption temperature. The scan shows progression of carbonation reactions upon uptake of CO₂ by MgO. Progression of reactions in the figure proceeds from the bottom trace to the top trace. XRD analysis of the sorbent prior to sorption (FIG. 2) shows multiple distinct and separate solid phases (identified by distinct peaks for each of these entities) in the sorbent including MgO, Na₂CO₃, and NaNO₃. During uptake of CO₂, [Trace-1] in the XRD (labeled as “Adsp. #1”) shows that a carbonation reaction proceeds between MgO and Na₂CO₃ as evidenced by the disappearance of the Na₂CO₃ phase, the decrease in the MgO phase, and the appearance of the Na₂Mg(CO₃)₂ reversible metal carbonate salt phase. In this system, MgCO3 does not form. The promoter, sodium nitrate (NaNO3), is not observed due to its presence as a molten salt in the sorbent during operation.

During desorption of CO2, [Trace-2] (labeled as “Desp. #1”) in the XRD shows that the CO2-laden sorbent releases CO₂, as demonstrated by the disappearance of the Na₂Mg(CO₃)₂ phase peak, with a corresponding increase in the MgO peak and the reappearance of the Na₂CO₃ peak in the XRD. Release of CO2 regenerates the sorbent. Results show the reaction that forms the Na₂Mg(CO₃)₂ metal carbonate salt (e.g., eitelite) is reversible. After a second sorption of CO₂, [Trace-3] in the XRD (labeled as “Adsp. #2”) shows the Na₂Mg(CO₃)₂ phase peak reappears. After desorption and release of CO2 from the sorbent, [Trace-4] (labeled as “Desp. #2”) the Na₂Mg(CO₃)₂ phase peak again disappears resulting in an increase in the MgO peak, and a reappearance of the Na₂CO₃ peak in the XRD.

In general, reversible metal carbonate salts formed upon uptake of CO2 by sorbents of the present invention (i.e., System-I, System-II, and System-III) are all thermodynamically stable salts that retain the sorbed (captured) CO2 until the sorbent is regenerated by release of captured CO2.

### Promoter Salts

Uptake of CO₂ by sorbents of the present invention can be facilitated by addition of a selected quantity of alkali-metal nitrate salts such as NaNO₃, alkali-metal nitrites, and/or eutectic mixtures of these various salts. Sorbents absent these compounds perform poorly. At the selected sorption temperatures, presence of these promoter salts enhances performance by facilitating reactions that yield the desired reversible metal carbonate salt products. Nitrate and nitrite promoter salts in these sorbents are not consumed in the sorption reactions. Nitrate and nitrite promoter salts in these sorbents melt at selected sorption temperatures and wet the surface of the solid-phase components enhancing uptake of CO₂.

In various embodiments, concentration of added nitrates may be below about 60 wt %. In some embodiments, concentration of added nitrates may be between about 4 wt % and about 40 wt %.

Uptake of CO₂ may also be promoted by group-I alkali-metal carbonate salts such as Na₂CO₃ and group-II alkaline-earth metal carbonate salts such as CaCO3. Addition of these compounds may shift or drive the equilibrium of the sorption reactions forward so that MgO may be converted to various reversible metal carbonate salt products. Quantity of added carbonates can be varied to adjust sorption (and desorption) temperatures of the sorbent materials. For example, in some embodiments, CO2 uptake by sorbents containing low carbonate concentrations between about 4 wt % and about 50 wt % may occur primarily through the conversion of MgO to MgCO₃. In these embodiments, low carbonate concentrations may adjust sorption and desorption temperatures upward by about 15° C.

In some embodiments, CO2 uptake by sorbents containing higher carbonate concentrations between about 30 wt % and about 70 wt % may occur primarily through conversion of MgO that forms regenerable (reversible) carbonate salts such as Na₂Mg(CO₃)₂ and/or CaMg(CO3)₂.

In systems where carbonate concentrations have overlapping ranges, uptake of CO2 by these sorbents may proceed by either process. For example, uptake of CO2 may yield reversible metal carbonate salts that include both MgCO3 and salts of the form M₂Mg(CO₃)₂ where (M) is the group-I alkali-metal (e.g., Na) and/or MMg(CO₃) where (M) is the group-II alkaline-earth metal (e.g., Ca), described previously. In addition, CO2 uptake in these sorbents may proceed under a first regime where sorption temperatures may be from about 380° C. to about 450° C., or under a separate regime where sorption temperatures are from about 300° C. to about 375° C. Varying the carbonate concentrations thus permits sorption temperatures and desorption temperatures to be tailored for selected applications. No limitations are intended.

### Sorption Results

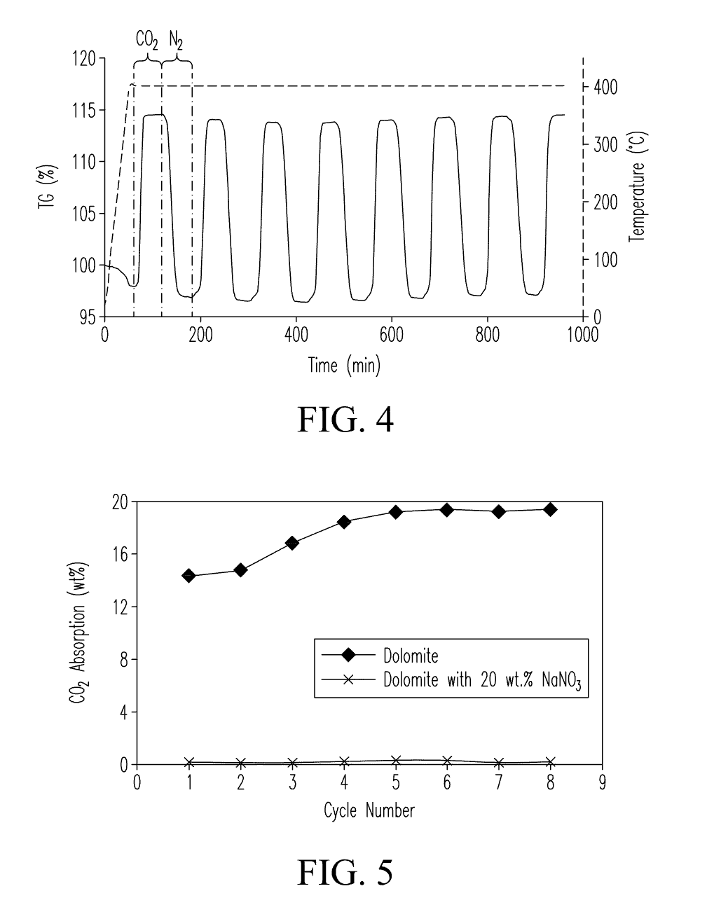

FIG. 4 shows CO₂ sorption results for one sorbent (e.g., of a System-I type) of the present invention at a selected sorption temperature under pressure swing test conditions. Results demonstrate that CO2 can be absorbed by a material comprising MgO, Na2CO3, and NaNO3 with a specific composition, thereby forming a double salt, which is capable of absorption and desorption of CO2 for several cycles without loss of capacity.

FIG. 5 shows CO₂ sorption results for dolomite with and without added nitrate at a selected sorption temperature under pressure swing test conditions in accordance with the process of the present invention. Results show that dolomite with added nitrate demonstrates an increasing sorption capacity for CO2 approaching about 20 wt % over 8 cycles.

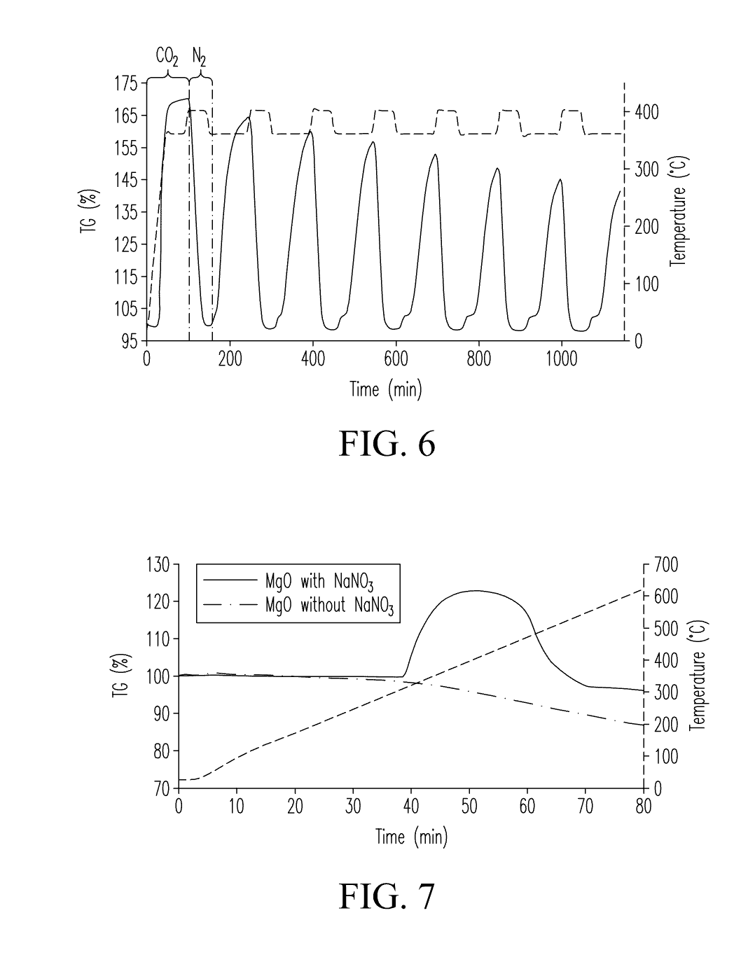

FIG. 6 shows CO₂ sorption results for another sorbent (e.g., of a System-III type) of the present invention at a selected sorption temperature under pressure swing test conditions. As shown in the figure, the MgO—Na2CO3 system (with added NaNO3) with a lower concentration of Na2CO3 can take up CO2 and includes a capacity greater than that that produces the double salt. This particular system, with 11% Na2CO3, has a capacity of approximately 45 wt % CO2 on the 7^{th} cycle of operation. Regeneration procedures still need to be optimized to avoid the progressive loss of capacity with cycle; however what is important to note is the high CO2 capacity compared with the double salt compositions.

FIG. 7 shows effect of alkali-metal nitrate salt addition on CO₂ sorption results in a selected sorbent (e.g., of a System-I type) of the present invention. As shown in the figure, while heating up in the presence of CO2, in the presence of NaNO3, the MgO-based sorbent experiences rapid weight gain starting at the melting point temperature of NaNO3 (308° C.) due to the significant uptake of CO2 by the MgO solid. Results further show that uptake of CO2 begins immediately upon melting of NaNO3. In contrast, in the absence of NaNO3, no CO2 is captured by MgO; a gradual weight loss was observed, attributed to loss of moisture and/or dehydroxylation of MgO. Results demonstrate the important role promoter salts play in facilitating capture of CO2 by MgO. TABLE 1 lists experimental results and properties for various nitrate-promoted MgO-based sorbent systems of the present invention.

TABLE 1
summarizes results conducted for three exemplary nitrate-promoted
MgO-based sorbent systems of the present invention.

| | Com- | Sorption | | Best | Capacity |
|---|---|---|---|---|---|
| | ponent | Tem- | Theoretical | Capacity | (actual) |
| | Ranges | peratures | Capacity | to date | after 8^{th} |
| System | (wt %) | (° C.) | (wt %) | (wt %) | cycle |
| I | | | | | |
| MgO: | 40-98 | 300-360 | 108 | 55 | 26 |
| NaNO3: | 2-60 | | | | |
| II | | | | | |
| MgO: | 20-66 | 380-450 | 30 | 20 | 20 |
| NaNO3: | 4-40 | | | | |
| Na2CO3: | 30-75 | | | | |
| III | | | | | |
| MgO: | 40-92 | 300-375 | 101 | 71 | 46 |
| NaNO3: | 4-40 | | | | |
| Na2CO3: | 4-50 | | | | |

CO2 sorption for sorbents was tested as a function of nitrate concentration in concert with a pressure swing at a fixed temperature of 400° C. TABLE 2 summarizes results obtained by varying nitrate concentrations in sorbents of the present invention including, e.g., MgO (e.g., of a System-I type), MgO—Na2CO3 (e.g., of a System-II type), and MgO—CaCO3 (e.g., of a System-II type). In some embodiments, the Na2CO3-MgO sorbent system may have a nitrate concentration of from about 4 wt % to about 24 wt %. In some embodiments, the nitrate concentration may be up to about 40 wt %. But, concentrations are not intended to be limited. For example, greater and lesser concentrations may be used depending on presence of other elements or desired effects. Thus, no limitations are intended. In other embodiments, other nitrate salts including, e.g., KNO3 and LiNO3 are also effective. In some embodiments, K2CO3 may be used in the sorbent to replace Na2CO3.

TABLE 2
summarizes CO2 sorption results as a function of nitrate concentration
in the sorbent admixture.

| | | | | | |
|---|---|---|---|---|---|
| | | | | CO₂ | |
| | | | Quantity | Capacity, 8^{th} | |
| Sample | Carbonate | | Nitrate | cycle | Sorption |
| ID | Additive | Nitrate | Wt % | (Wt %) | Product |

Metal Oxide (MgO) + Group-I Carbonate + Group-I Nitrate

| | | | | | |
|---|---|---|---|---|---|
| 1 | Na₂CO₃ | — | 0 | 3.5 | Na₂Mg(CO₃)₂ |
| 2a | Na₂CO₃ | NaNO₃ | 2 | 4.1 | Na₂Mg(CO₃)₂ |
| 2b | Na₂CO₃ | NaNO₃ | 4 | 17.0 | Na₂Mg(CO₃)₂ |
| 2c | Na₂CO₃ | NaNO₃ | 12 | 17.2 | Na₂Mg(CO₃)₂ |
| 2d | Na₂CO₃ | NaNO₃ | 24 | 15.2 | Na₂Mg(CO₃)₂ |
| 2e | Na₂CO₃ | NaNO₃ | 30 | 11.8 | Na₂Mg(CO₃)₂ |
| 2f | Na₂CO₃ | NaNO₃ | 40 | 0.2 | Na₂Mg(CO₃)₂ |
| 3a | Na₂CO₃ | LiNO₃ | 12 | 17.7 | Na₂Mg(CO₃)₂ |
| 3b | Na₂CO₃ | KNO₃ | 12 | 17.1 | Na₂Mg(CO₃)₂ |
| 4a | K₂CO₃ | NaNO₃ | 12 | 8.4 | K₂Mg(CO₃)₂ |
| 4b | K₂CO₃ | — | 0 | 3.9 | K₂Mg(CO₃)₂ |

Metal Oxide (MgO) + Group-I Carbonate + Group-I Nitrate

| | | | | | |
|---|---|---|---|---|---|
| 5a | CaCO₃ | NaNO₃ | 15 | 19.4 | CaMg(CO₃)₂ |
| 5b | CaCO₃ | — | 0 | 0 | — |

Data show the enhancement of sorption capacities by addition of various nitrate salts (e.g., NaNO₃, LiNO₃, KNO₃). Different nitrates work equally well as promoters of the sorption reactions, and further show that in the absence of such nitrates, CO2 sorption is poor. In particular, nitrate concentrations below 4 wt % are less effective at capturing CO2. And, at nitrate concentrations above 40 wt %, sorption of CO2 can be substantially reduced.

### Effects of Added Carbonate on CO2 Sorption/Desorption Temperature

CO2 sorption capacity of sorbents containing various concentrations of added carbonates was tested in concert with a pressure swing at a fixed temperature of 400° C. TABLE 3 compares results for sorbents containing, e.g., MgO, MgO with lower concentrations (˜11 wt %) of added carbonates, and MgO with higher concentrations (˜40 wt %) of added carbonates. Effect of added carbonates on both sorption and desorption temperatures, as well as sorption capacity are listed.

TABLE 3
compares CO2 sorption results as a function of added carbonate in
various sorbent mixtures.

| | | | Selected | | |
|---|---|---|---|---|---|
| | | | Test | CO₂ | |
| | | Qty | Temperatures | Capacity, | Principle |
| Sample | Carbonate | (Wt | (Sorb/Desorb) | 8^{th} cycle | Sorption |
| ID | Additive | %) | (° C.) | (Wt %) | Product |
| 6 | — | — | 330/375 | 25.6 | MgCO₃ |
| 7a | Na₂CO₃ | 11 | 360/400 | 43.8 | MgCO₃ |
| 7b | Na₂CO₃ | 44 | 400/400 | 17.2 | Na₂Mg(CO₃)₂ |
| 8a | CaCO₃ | 11 | 360/400 | 44.2 | MgCO₃ |
| 8b | CaCO₃ | 55 | 380/400 | 17.1 | CaMgCO₃ |

Sorption temperature may increase with an increasing concentration of added carbonate (e.g., Na2CO3). Added carbonates may allow sorption temperatures of the sorbent materials to be tuned for a desired performance metric while maintaining high CO2 sorption capacity. Results further demonstrate that it is possible to capture CO2 with sorbent compositions that include varying quantities of the reversible metal carbonate salt product. For example, conditions that yield little of the reversible metal carbonate salt product can differ significantly from conditions that yield the metal carbonate as a principle product. Yet, conditions for capture and release CO2 can be varied by varying the amount of Na2CO3, e.g., from 0 wt %, to 11 wt %, to 44 wt %, and other formulations. No limitations are intended by a presentation of these exemplary concentrations.

Similar results can be demonstrated for the CaMg(CO3)2 system. Data show that sorbents may perform differently at different operation temperatures, with different concentrations of added carbonates (e.g., Na2CO3 or CaCO3), and without additives. In particular, sorbent performance at different operation temperatures is sensitive to concentrations of added alkali-metal nitrate salts and carbonate salts such as Na2CO3 or CaCO3.

### Melting Temperatures of Sorbent Additives and Starting Temperature of CO₂ Sorption

TABLE 4 lists melting temperatures of nitrate additives in the sorbent and the starting temperatures for CO₂ uptake by MgO in the sorbent.

TABLE 4
lists melting temperatures of nitrate additives in the sorbent and
starting temperatures for CO₂ uptake by MgO in the sorbent admixture.

| | | | Melting | CO₂ | |
|---|---|---|---|---|---|
| | | | Point | Uptake | |
| | | | Temperature | Starting | Oxide to |
| | | | of | Temper- | Carbonate |
| Sample | Metal | Nitrate Salt | Nitrate Salt | ature | Conversion |
| ID | Oxide | Composition | (° C.) | (° C.) | (%) |
| 9 | MgO | NaNO₃ | 308 | 308 | 69 |
| 10 | MgO | NaNO₂ | 271 | 271 | 63 |
| 11 | MgO | NaNO₃/ | 221 | 221 | 77 |
| | | KNO₃ | | | |
| | | (eutectic) | | | |
| 12 | MgO | NaNO₃/ | 140 | 140 | 88 |
| | | NaNO₂/ | | | |
| | | KNO₃ | | | |
| | | (eutectic) | | | |
| 13 | CaO | NaNO₃ | 308 | 308 | 29 |
| 14 | CaO | NaNO₃/ | 140 | 140 | 29 |
| | | NaNO₂/ | | | |
| | | KNO₃ | | | |
| | | (eutectic) | | | |

Data show that the initiation of uptake of CO2 by MgO-based sorbents of the present invention may depend on the selected alkali metal nitrate salts, nitrite salts, and eutectics employed. In some embodiments, NaNO3 may be used. In some embodiments, alternate nitrate salts may be used. Melting temperatures may also be varied by adding and varying the concentrations of eutectics composed of, e.g., various nitrite salts, nitrate-nitrate salts, and nitrate-nitrite salts. Results further show that sorption temperatures may be selected and/or adjusted by selecting a suitable salt or salts for the sorbent that include different melting point temperatures that allow a desired range of CO2 sorption temperatures to be selected. Results show uptake of CO2 begins at the temperature when these various salts in the sorbent melt. For example, in cases where salts are employed in the sorbent having a melting point temperature below that of NaNO3 (e.g., with melting temperatures between about 70° C. to about 300° C.), temperature of CO2 capture by the sorbent may be lowered correspondingly. In various embodiments, CO2 capture may be initiated immediately upon melting of the promoter salt. In an alternate system containing CaO solid, data further show that CaO can sorb CO2 at temperatures as low as 140° C. when promoted by a eutectic salt or a lower-melting salt. It should be noted that lower CO2 uptake temperatures in the presence of lower melting salts does not mean that lower regeneration temperatures are obtained. Regeneration temperatures are fixed by thermodynamics of the system employed.

### Reactors for Warm Temperature Removal of CO2

Reactors suitable for use with sorbents of the present invention for warm temperature removal of CO₂ from selected gases are not limited. Exemplary reactors include, but are not limited to, e.g., fluid-bed reactors, fixed-bed reactors, moving-bed reactors, static reactors, transport reactors, membrane reactors, and the like, or combinations of these various reactors. No limitations are intended.

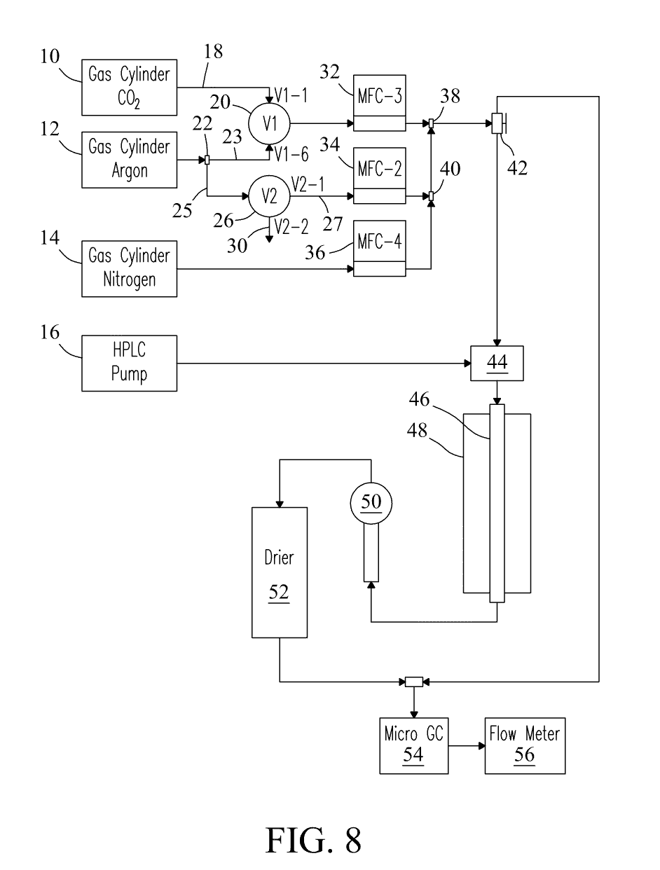

FIG. 8 shows a schematic of a fixed-bed reactor that may be used to test sorbents of the present invention for warm temperature removal of CO₂. In the figure, a tube reactor 46 constructed of Hastelloy C alloy may be loaded with sorbents as described herein. A furnace 48 (e.g., tube furnace, Analytical Instruments, Minneapolis, Minn., USA) may be used to heat reactor 46 to selected sorption and desorption temperatures.

A gas cylinder 10 containing CO2 gas may be used as a source of CO2. Gas cylinder 10 may be filled with other CO2-containing gases, e.g., premixed gases to simulate various syngas conditions. For example, gas cylinder 10 may contain a gas composed, e.g., of 20% CO2 premixed with H2 as a balance gas as a source of CO2. Other gases may be delivered individually or be combined and/or premixed to provide a simulant syngas for testing or for calibration. For example, another gas cylinder 14 containing, e.g., N2 gas may deliver a balance gas that adjusts concentrations of CO2 gas delivered from gas cylinder 10 as a CO2 gas source to reactor 46. Thus, no limitations are intended. Another gas cylinder 16 containing, e.g., an inert gas such as argon (Ar) gas may be used as a purge gas to regenerate the sorbent. Other inert gases (e.g., N2), steam, CO2 lean/free gases may also be introduced to the configuration without limitation. All gases and gas sources as will be implemented by those of ordinary skill in the art in view of the disclosure are within the scope of the invention.

In the figure, valves (V1) 20 and (V2) 26 (e.g., six-way valves, Valco Instruments Co. Inc., Houston, Tex., USA) may permit switching between selected gases at selected or periodic time intervals. For example, during sorption, CO2-containing gas from cylinder 10 may be delivered through gas transfer line (e.g., V1-1) 18 and introduced through valve (V1) 20 and delivered to mass flow controller (e.g., MFC-3) 32. Mass flow controllers (MFC) 32, 34, 36 (e.g., Brooks Instrument, Hatfield, Pa., USA) may be used to control gas flow rates into reactor 46. During desorption, transfer line 18 to valve (V1) 20 may be closed. Regeneration gas (e.g., Ar) from cylinder 12 may be delivered through a tube T-connection 22. T-connection 22 may separate into two transfer lines 23 and 25. Regeneration gas may be delivered through transfer line (e.g., V1-6) 23 through valve (V1) 20 into mass flow controller (e.g., MFC-3) 32. The other transfer line 25 to valve (V2) 26 may be positioned (i.e. opened) to allow purge gas to flow into gas transfer line (e.g., V2-1) 27, which delivers regeneration purge gas to mass flow controller (MFC-2) 34, e.g., as an extra regeneration gas. Transfer line (e.g., V2-2) 30 may be used, e.g., to vent gas. T-connections 38 and 40 may be coupled to deliver separate gas flows from respective mass-flow controllers (MFC) 32, 34, and 36 to a three-way valve 42. Three-way valve 42 may provide individual or mixed gases to (water) vaporizer 44. Vaporizer 44 may be configured to provide steam into each individual or mixed gas before the gases enter reactor 46. In another position, three-way valve 42 may also direct the flow of gases such that they bypass reactor 46 and directly enter GC 54 for calibrations involving these various individual or mixed gases. HPLC pump 16 may be used to control the quantity of steam delivered from vaporizer 44 to reactor 46. Condenser 50 and drier tube 52 may be used to remove steam added in the reactant gas before the now CO2-depleted gas (e.g., effluent gas or off-gas) is introduced into GC 54 (Agilent Technologies, Santa Clara, Calif., USA) or another analytical instrument or system to avoid damaging the analytical system with steam. Drier tube 52 may be used to remove residual steam from the off-gas. GC 54 may be used to monitor gas composition and measure CO2 in the off-gas to assess sorbent performance. Flow meter 56 (e.g., Bios DryCal® Technology) (MesaLabs, Lakewood, Colo., USA) may be used to determine the flow rate of gas into GC 54 or another analytical system.

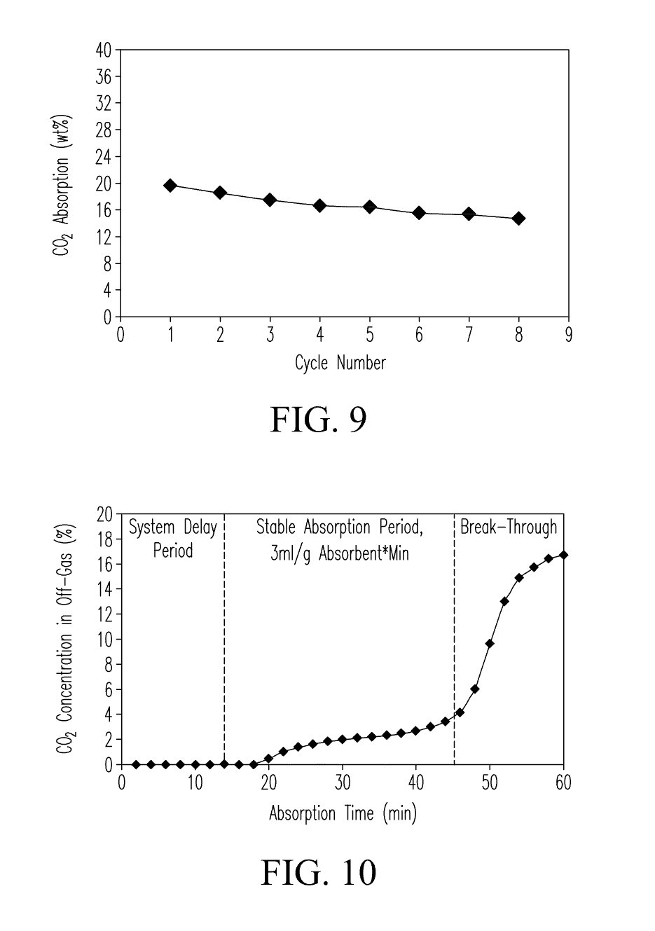

FIG. 9 shows CO2 sorption capacity for a selected sorbent (e.g., System-II) of the present invention as a function of cycle number in a fixed bed reactor. Results show a CO2 sorption capacity of from about 16 wt % to about 20 wt % after eight sorption cycles and desorption cycles. Results demonstrate feasibility of using sorbents of the present invention for capture of CO2, e.g., in reactor operation. In some applications, capture of warm CO₂ in a reactor may offer a competitive advantage, e.g., where sorbents described herein can absorb CO₂ from gas streams as-received from a gasifier. In other applications, capture of CO2 may also be combined with a synthesis process that captures CO₂ at the same time providing an ability to shift synthesis equilibria to higher conversions by removal of co-produced CO₂.

In other applications, activation of mineral compounds that converts the mineral compounds into effective CO₂ sorbents materials may provide ways to use existing mineral compounds and produce regenerable CO₂ sorbents. In other applications, sorbents of the present invention may find uses for CO₂ sequestration. All applications as will be implemented by those of ordinary skill in the art in view of this disclosure are within the scope of the invention.

### Break-Through Tests

FIG. 10 is a CO2 sorption breakthrough curve for a sorbent of the present invention that plots CO2 concentration in the off-gas as function of time. Results demonstrate that the sorbent removes between about 80% to about 90% of CO2 by volume in the gas stream. Results further show that the sorbent provides a stable CO2 sorption platform for removing CO2 at a rate of at least about 3 mL/gram of sorbent per minute.

### Regeneration of Sorbent

Regeneration of the sorbent can be achieved in concert with either a temperature swing condition or a pressure swing condition. “Temperature Swing” as used herein means a swing in temperature of between about 380° C. and about 470° C. “Pressure Swing” as used herein means a wide swing in pressure. In some embodiments, the pressure swing may be conducted at a leading pressure (i.e., during sorption) of from about 0.8 bar to about 4 bar with a swing to below about 0.05 bar (i.e., during desorption) at a fixed regeneration temperature, e.g., 400° C. However, no limitations are intended. For example, in some embodiments, the pressure swing may include changing the partial pressure of the CO₂-containing gas introduced to the sorbent at a fixed temperature. In some embodiments, the pressure swing may include purging the sorbent with a purge gas to release CO₂ from the sorbent. Purge gases may include, e.g., steam, inert gases, nitrogen-containing gases, CO₂-lean gases, CO₂-free gases, including combinations of these various gases.

### EXAMPLES

The following examples provide a further understanding of aspects of the present invention described herein.

### Example 1

### System-I

### Na2CO3-MgO, no NaNO3

The sample was prepared as follows. Mg₅(CO₃)₄(OH)₂.xH₂O powder (99%, Sigma Aldrich) was calcined at 450° C. for 3 hours to form MgO. 2 grams of the MgO powder was mixed with 2 grams of Na₂CO₃ (99.95%, Sigma Aldrich, USA) for a total yield of 4 grams. 50 grams of isopropyl alcohol and 72 grams of zirconia beads (1 cm diameter) were added to the solid MgO powder in a 250 mL Nalgene plastic bottle. The bottle was placed on a rotary milling machine and the mixture was ball milled for 48 hours at a speed of 60 rpm. The slurry was dried at 60° C. for 4 hours to evaporate and remove the isopropyl milling medium from the slurry forming a powder cake. Following drying, the powder cake was calcined in air at 450° C. for 3 hours to form the sorbent powder. Sorption capacity of the synthesized sorbent was measured using a thermogravimetric analyzer (e.g., an STA 409 TGA cell, Netzsch Thermiche Analyse Instruments, LLC, Burlington, Mass., USA) through pressure swing absorption (PSA) at ambient pressure. Test weight of the sorbent sample was ˜20 mg. The PSA test temperature was 400° C. The initial heating from room temperature to the absorption temperature was conducted in 100% N2 to avoid absorption before reaching the desired temperature. Upon reaching the desired test temperature, the swing test was carried out by exposing the sample to alternating 100% CO2 for 60 minutes and 100% N2 for 60 minutes at 400° C. Test results for this sample are listed in TABLE 2 (see Sample 1).

### Example 2

### System-II

### Na2CO3-MgO, 2% NaNO3

Samples were prepared and tested as described in EXAMPLE 1. Two (2) grams of Na₂CO₃, 2 grams of MgO, and 0.1 grams of NaNO₃ were ball milled in 50 grams of isopropyl alcohol. Sorption capacity of the sample was tested. Results are listed in TABLE 2 (see Sample 2a). Additional tests were conducted with NaNO₃ concentrations of 4 wt % (Sample 2b), 12 wt % (Sample 2c), 24 wt % (Sample 2d), 30 wt % (Sample 2e), and 40 wt % (Sample 2f).

### Example 3

### System-II

### Na2CO3-MgO-12% LiNO3 or KNO3

Samples were prepared and tested as described in EXAMPLE 1. 2.2 grams of Na₂CO₃, 2.2 grams of MgO, and 0.6 grams of LiNO3 were ball milled in 50 grams of isopropyl alcohol as a milling medium. Test results are listed in TABLE 2 (see Sample 3a). In another test, 2.2 grams of Na₂CO₃, 2.2 grams of MgO, and 0.6 grams of KNO3 were ball milled in 50 grams of isopropyl alcohol. Test results are listed in TABLE 2 (see Sample 3b).

### Example 4

### System-II

### K2CO3-MgO-12% NaNO3 and without NaNO3

Procedure of EXAMPLE 1 was followed. 2.2 grams of K2CO3 (Sigma Aldrich), 2.2 grams of MgO, and 0.6 grams of NaNO₃ were ball milled in 50 grams of isopropyl alcohol. Sample was analyzed by TGA. Test results are listed in TABLE 2 (see Sample 4a). In another test, 2 grams of K2CO3 and 2 grams of MgO were ball milled in 50 grams of isopropyl alcohol. Test results are listed in TABLE 2 (see Sample 4b).

### Example 5

### System-III

### CaCO3-MgO-20 wt % NaNO3

Procedure of EXAMPLE 1 was followed. CaCO3-MgO powder was obtained by partially decomposing dolomite powder (City Chemical, West Haven, Conn., USA) at 450° C. for 3 hours. 2.0 grams of CaCO3-MgO powder was mixed with 0.5 grams of NaNO3 (≧99.0%) (Sigma Aldrich, St. Louis, Mo., USA), for a total sample weight of 2.5 grams. 50 grams of isopropyl alcohol (milling medium) and 192 grams of zirconia beads (96 g of 1 cm diameter beads and 96 g of 0.3 cm diameter beads) were added to the solid powder in a 250 mL Nalgene plastic bottle. The bottle was placed on a rotary milling machine and the mixture was ball milled for 48 hours at a speed of 60 rpm. The slurry obtained was dried at 60° C. for 4 hours to evaporate and remove the isopropyl alcohol. Following drying, the cake was calcined in air at 450° C. for 3 hours. Test results are listed in TABLE 2 (see Sample 5a). In another test, CaCO3-MgO powder was directly analyzed. Test results are listed in TABLE 2 (see Sample 5b).

### Example 6

### System-I

### MgO-15 wt % NaNO3

Sample preparation and TGA procedure of EXAMPLE 1 were followed. 1.7 grams of MgO and 0.6 grams of NaNO3 were ball milled in 50 grams of isopropyl alcohol. Multi-cycle absorption capacity of the sorbent sample was measured using a TGA analyzer (Netzsch Instruments) in a combined swing sorption measurement at ambient pressure. ˜20 mg of sorbent was tested. Sample was heated from room temperature to the sorption temperature (330° C.) in 100% N₂ to prevent sorption before reaching the desired sorption temperature. Sorption was conducted in 100% CO2 at 330° C. for 60 minutes. Desorption was conducted in 100% N₂ at 375° C. for 60 mins. Test results are listed in TABLE 3 (see Sample 6).

### Example 7

### System-II

### Na2CO3-MgO, 11 wt % and 44 wt % Na2CO3

Sample preparation and TGA testing were performed as in Example 1. 3.1 grams of MgO was mixed with 0.4 grams of Na2CO3 and 0.5 grams of NaNO₃ (≧99.0%) (Sigma Aldrich) for a total of 4 grams of sample. Multi-cycle sorption capacity of the sample was measured by TGA in a combined swing sorption measurement at ambient pressure. ˜20 mg of sorbent was tested. Sample was heated from room temperature to the sorption temperature (360° C.) in 100% CO₂ to observe the CO2 uptake during ramping. Sorption was conducted in 100% CO2 at 360° C. for 90 minutes. Desorption was conducted in 100% N₂ at 400° C. for 60 mins. Test results are listed in TABLE 3 (see Sample 7a). In another test, 12 wt % NaNO3 was added to the sample. Results are listed in TABLE 3 (see Sample 7b).

### Example 8

### System-II

### CaCO3-MgO, 11 wt % and 55 wt % CaCO3

Samples were prepared as in EXAMPLE 1. CaCO3 was obtained by calcining calcium acetate hydrate (97%, Alfa Aesar, Ward Hill, Mass., USA) at 500° C. for 4 hrs. 1.5 grams of MgO was mixed with 0.22 grams of CaCO3 and 0.24 grams of NaNO₃ (≧99.0%) (Sigma Aldrich), with an expected total yield of 2 grams. 8 grams of 2-propanol and 30 grams of zirconia beads (10 g of 1 cm diameter beads and 20 g of 0.3 cm diameter beads) were added to the solid powder and the mixture was ball-milled for 60 hours in a 25 mL Nalgene plastic bottle. The slurry was dried at room temperature for 4 hours to evaporate 2-propanol from the sample. After drying, the powder cake was calcined in air at 450° C. for 3 hours. TGA procedure of EXAMPLE 7 was followed. Test results are listed in TABLE 3 (see Sample 8a). In another test, 1.0 g of MgO was mixed with 2.2 grams of CaCO3 (Sigma, Bio-reagent) and 0.8 grams of NaNO₃ (≧99.0%) (Sigma Aldrich) for a total sample size of 4 grams. TGA procedure of EXAMPLE 1 was followed. Test results are listed in TABLE 3 (see Sample 8b).

### Example 9

### System-I

### Control of Uptake Temperature by Addition of Promoter Salt, NaNO3

Effect of adding promoter salts to a sorbent was tested. In one test, ˜20 mg of NaNO3 was melted by heating the salt alone. The salt was then cooled and about 10 mg of MgO was added. CO2 uptake by the sorbent mixture was tested in a sorption test by heating the sorbent in 100% CO2 in a TGA analyzer to a temperature of 600° C. at a heating rate of 7.5° C./min. Test results are listed in TABLE 4 (see Sample 9). Sample results with and without added NaNO3 are compared in FIG. 7.

In another test ˜20 mg of another promoter salt, NaNO2, was melted by heating the salt alone. The system was then cooled and about 10 mg of MgO was added. CO2 uptake by the sorbent mixture was tested in the TGA. Test results are listed in TABLE 4 (see Sample 10).

In another test, 8 mg of KNO3 and 12 mg of NaNO3 were mixed and melted by heating the salts alone to form a eutectic mixture. The system was then cooled and about 10 mg of MgO was added. CO2 uptake was tested as described above. Test results are listed in TABLE 4 (see Sample 11).

In another test, a eutectic mixture containing 10.6 mg of KNO3, 8 mg of NaNO3, and 1.4 mg of NaNO2 was heated to melt the promoter salts together. The system was cooled and about 10 mg of MgO was added. CO2 uptake by the sorbent mixture was tested in the TGA. Test results are listed in TABLE 4 (see Sample 12).

In another test, a melt containing about 20 mg of NaNO3 was first formed by heating the salt alone. The system was then cooled and about 10 mg of CaO was added. A CO2 sorption test was conducted in the TGA as described above. Test results are listed in TABLE 4 (see Sample 13).

In yet another test, a eutectic mixture containing 10.6 mg of KNO3, 8 mg of NaNO3, and 1.4 mg of NaNO2 was heated to melt the promoter salts together. The system was cooled and about 10 mg of CaO was added. A sorption test was conducted in the TGA as described above. Test results are listed in TABLE 4 (see Sample 14).

### Example 10

### In-Situ XRD Analysis

### (FIG. 3)

CO2 absorption during in-situ XRD measurement (Bruker D8 ADVANCE) was conducted on a sorbent containing Na2CO3-MgO and NaNO3 at a scanning rate of 2°/min with Cu Kα radiation. Peaks for NaNO3 were not observed because NaNO3 became molten at the absorption and desorption temperature and did not possess crystal structure for X-ray detection. About 0.5 grams of absorbent was loaded for the measurement. The absorbent was preheated to 380° C. in 100% N2 to avoid absorption before reaching the desired temperature. After reaching 380° C., the gas was switched to 100% CO2 and the following measurement was conducted through a temperature swing between 380° C. and 470° C. in a 100% CO2 environment. During sorption, the scan was taken after the sorbent was exposed to CO2 for 30 minutes at 380° C. After the sorption scan was completed, temperature was increased to 470° C. and the temperature was maintained for 20 minutes. Then, the desorption scan was collected. FIG. 3 shows results from this experiment.

### Example 11

### Fixed Bed Reactor Operation

The sorbent used for the fixed bed test was prepared as described in EXAMPLE 2 (Sample 2c). After calcination, a white absorbent in the shape of cm-sized plates was obtained. Samples were ground to a mesh size of between about 40 mesh and about 80 mesh. The fixed bed reactor of FIG. 8 was used for the tests. 1.7 grams of a sized sorbent (e.g., of a System-II type) was loaded into a reactor constructed of Hastelloy C with an inner diameter of 0.76 cm which was maintained at a temperature of 380° C. A syngas simulant composed of 20% CO2 in hydrogen (H2) as the balance gas. The pre-mixed gas was used instead of mixing preselected gases through the reactor. Therefore, the gas cylinder containing CO2 was not used. Test pressure was 232 psi. A gas hourly space velocity (GHSV) of about 650 hr⁻¹ was used. Sorption for each cycle was conducted at 380° C., in 20% CO2/H2, for 60 minutes. Simulant gas was then flowed through the sorbent at a selected rate. Steam was not introduced into the feed gas. Each sorption cycle was 60 minutes. After each sorption cycle, the simulant gas was switched to an argon (Ar) purge gas and the temperature was ramped to 460° C. at a heating rate of 8° C./min. Temperature was maintained for a period of 30 minutes to regenerate the sorbent. The furnace was then cooled to 380° C. at a rate of 2° C./min and maintained for 10 min prior to the next sorption cycle. CO2 concentration in the effluent gas at the outlet to the reactor was recorded with a GC (e.g., Micro GC, Agilent). Results are shown in FIG. 9 and FIG. 10.

While exemplary embodiments of the present invention have been shown and described, it will be apparent to those skilled in the art that many changes and modifications may be made without departing from the invention in its true scope and broader aspects. The appended claims are therefore intended to cover all such changes and modifications as fall within the spirit and scope of the invention.

What is claimed is:

1. A multi-phase sorbent for sorption of CO2 from a CO2-containing gas, the sorbent comprising:
magnesium oxide and one or more alkali-metal nitrates;
optionally an alkali metal carbonate and/or an alkaline-earth metal carbonate;
wherein the mixture forms a regenerable (reversible) solid metal carbonate salt upon sorption of CO₂ at a temperature above ambient and below 600° C. that removes CO2 from the CO2-containing gas and yields a CO₂-depleted gas.

2. The sorbent of claim 1, wherein the magnesium oxide has a concentration between about 40 wt % and about 98 wt %, and the nitrates have a concentration between about 2 wt % and about 60 wt %.

3. The sorbent of claim 1, wherein the magnesium oxide has a concentration between about 20 wt % and about 66 wt %, the nitrates have a concentration between about 4 wt % and about 40 wt %, and the group-I alkali metal carbonate and/or the group-II alkaline earth metal carbonate has a concentration of between about 30 wt % and about 75 wt %.

4. The sorbent of claim 1, wherein the magnesium oxide has a concentration between about 40 wt % and about 92 wt %, the nitrates have a concentration between about 4 wt % and about 40 wt %, and the group-I alkali metal carbonates and/or group-II alkaline earth metal carbonates have a concentration of between about 4 wt % and about 50 wt %.

5. The sorbent of claim 1, wherein the alkali-metal nitrates can include one or more alkali-metal nitrites or their eutectic mixtures that melt and wet the surface of the solid phase components in the sorbent at the selected sorption temperature.

6. A method for removing CO₂ from a CO₂-containing gas, comprising the step of:
sorbing CO₂ from the CO₂-containing gas at a selected temperature above ambient and below 600° C. in a multi-phase sorbent comprising a mixture of magnesium oxide in a solid state and one or more alkali-metal nitrates in a molten state; and optionally an alkali metal carbonate and/or an alkaline-earth metal carbonate, forming a reversible solid metal carbonate salt upon sorption yielding a CO₂-depleted gas.

7. The method of claim 6, wherein the sorption temperature is up to about 360° C.; or between about 300° C. and about 360° C.

8. The method of claim 6, wherein the sorption includes forming MgCO3.

9. The method of claim 6, wherein the sorption includes a sorption capacity up to about 55 wt %; or up to about 108 wt %.

10. The method of claim 6, wherein the sorption temperature is between about 380° C. and about 450° C.

11. The method of claim 6, wherein the sorption includes forming (M)₂Mg(CO₃)₂ where (M) is a Group-I alkali metal and/or (M)Mg(CO₃)₂ where (M) is a Group-II alkaline-earth metal.

12. The method of claim 6, wherein the sorption includes a sorption capacity up to about 20 wt %; or up to about 30 wt %.

13. The method of claim 6, wherein the sorption temperature is up to about 375° C. or between about 300° C. and about 375° C.

14. The method of claim 6, wherein the sorption includes forming MgCO₃ and (M)₂Mg(CO₃)₂ where (M) is a Group-I alkali metal and/or (M)Mg(CO₃)₂ where (M) is a Group-II alkaline-earth metal.

15. The method of claim 6, wherein the sorption includes a sorption capacity up to about 71 wt %; or up to about 101 wt %.

16. The method of claim 6, wherein the alkali-metal nitrates can include one or more alkali-metal nitrites or their eutectic mixtures that melt and wet the surface of the solid phase components in the sorbent at the selected sorption temperature.

17. The method of claim 6, further including regenerating the sorbent by releasing CO₂ from the sorbent with a thermal swing or a pressure swing or a combination of same.

18. The method of claim 17, wherein the thermal swing includes changing the temperature of the sorbent from a sorption temperature to a desorption temperature or vice versa.

19. The method of claim 17, wherein the thermal swing is performed at a temperature greater than or equal to about 400° C.

20. The method of claim 17, wherein the regeneration includes changing the partial pressure of the CO₂-containing gas introduced to the sorbent with a pressure swing conducted at a fixed temperature.

21. The method of claim 17, wherein the regeneration includes introducing a purge gas to the CO₂-laden sorbent in concert with a temperature-swing or a pressure-swing to release CO₂ from the sorbent, regenerating the sorbent.

22. The method of claim 17, wherein the regeneration includes introducing a purge gas to the CO₂-laden sorbent disposed within a reactor at a temperature-swing condition or a pressure-swing condition or a combination of same to release CO₂ from the sorbent, regenerating the sorbent in the reactor.

23. A system for removing CO₂ from a CO₂-containing gas, the system comprising:
a reactor containing a sorbent comprising a mixture of magnesium oxide in a solid state and one or more alkali-metal nitrates in a molten state, and optionally an alkali metal carbonate and/or an alkaline-earth metal carbonate configured to sorb CO₂ from the CO₂-containing gas when in operation at a selected sorption temperature above ambient and below 600° C. that forms a reversible solid metal carbonate salt upon sorption of CO₂ that yields a CO₂-depleted gas.
